(19) United States
(12) Patent Application Publication
(10) Pub. No.: US 2007/0124274 A1
(43) Pub. Date: May 31, 2007

(54) Apparatus and method for autonomic adjustment of resources in a logical partition to improve partitioned query performance

(75) Inventors: Eric Lawrence Barsness, Pine Island, MN (US); John Matthew Santosuosso, Rochester, MN (US)

Correspondence Address: MARTIN & ASSOCIATES, LLC, P.O. BOX 548, CARTHAGE, MO, 64836-0548, US

(73) Assignee: INTERNATIONAL BUSINESS MACHINES CORPORATION, ARMONK, NY (US)

(21) Appl. No.: 11/290,872

(22) Filed: Nov. 30, 2005

(51) Int. Cl. G06F 17/30

(52) U.S. Cl. 707/2

(57) ABSTRACT

In a partitioned database system that includes multiple logical partitions, query performance is estimated with a current allocation of resources. A determination is made whether additional resources are available or whether resources could be reallocated from one logical partition to a different logical partition. Query performance is then estimated again with a proposed reallocation of resources. This process continues iteratively until an allocation of resources is determined that will enhance the performance of the query. A resource allocation mechanism then initiates the reallocation of resources. In this manner, resources in logical partitions may be dynamically and autonomically reallocated to improve the performance of a query to a partitioned database.

### BACKGROUND OF THE INVENTION

1. Technical Field

This invention generally relates to computer systems, and more specifically relates to partitioned databases.

2. Background Art

Database partitioning is the process of distributing a file across a set of nodes in what is commonly referred to as a node group. Data from a table can be placed on a single node, or may be spread across multiple nodes. For example, in the sample prior art system 200 shown in FIG. 2, a database is partitioned among multiple systems. Thus, a first system 260A includes a first database partition 270, other systems (not shown) may include other database partitions, and an Nth system 260N includes an Mth database partition 270M. The various partitions in the database are managed by a database partition manager 230 within a database manager 220. An application 210 that requests data from the partitioned database does not know that the database is partitioned. In other words, the partitioning of the database is hidden from the application 210. From the application point of view, a query is submitted to the database manager 220, which returns the result set that satisfies the query.

Planning for database partitioning is not a simple task, and involves thinking about various issues, including 1) how the data is systematically divided for placement in different database partitions; 2) what data is frequently joined in a query; 3) what is a meaningful choice when doing selections; and 4) what is the most efficient way to setup the partitions to get the needed data. When planning the partitioning of a database, the fastest systems should typically receive the most data. This is logical since the response time is determined by the slowest node. Due to the difficulty in determining everything correctly at the time the database partitions are created, and due to the fact that database access behavior changes over time and as the amount of data builds up, many partitioned databases do not operate as efficiently as they could, and indeed, as efficiently as they used to.

One important feature of most database systems is the evaluation of query performance. A query optimizer 240 is typically provided that includes a performance estimator 250. The performance estimator 250 estimates performance of a query, typically by dividing the query into sub-parts, then estimating the performance for each sub-part. The query optimizer 240 may try different access plans to implement a query, and typically determines using the performance estimator 250 which access plan provides the best performance for implementing the query.

The evolution of a partitioned database over time may slow down its performance. Known database systems require manual reconfiguration of a partitioned database system. Thus, if a partitioned database system slows down over time, a system administrator will typically look at the database partitioning and the allocation of system resources to determine whether a change could be made to improve performance of the partitioned database. Without a way to autonomically detect when a configuration change would benefit system performance and autonomically reallocate system resources to effect the configuration change, the computer industry will continue to suffer from partitioned database systems that must be manually reconfigured by a system administrator to improve performance.

### DISCLOSURE OF INVENTION

According to the preferred embodiments, in a partitioned database system that includes multiple logical partitions, query performance is estimated with a current allocation of resources. A determination is made whether additional resources are available or whether resources could be reallocated from one logical partition to a different logical partition. Query performance is then estimated again with a proposed reallocation of resources. This process continues iteratively until an allocation of resources is determined that will enhance the performance of the query. A resource allocation mechanism then initiates the reallocation of resources. In this manner, resources in logical partitions may be dynamically and autonomically reallocated to improve the performance of a query to a partitioned database.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 is a block diagram of a prior art system that includes a partitioned database;

FIG. 3 is a block diagram of a system in accordance with the preferred embodiments for autonomically reallocating resources in one or more logical partitions to improve the performance of queries in a partitioned database;

FIG. 4 is a flow diagram of a method for dynamically reallocating resources in one or more logical partitions in system 300 in FIG. 3 in accordance with the preferred embodiments to improve performance of a query to a partitioned database;

FIG. 5 is a block diagram of a system in accordance with the preferred embodiments that is one specific example of system 300 of FIG. 3; and

FIG. 6 is a flow diagram of a method for dynamically reallocating resources in one or more logical partitions in system 500 in FIG. 5 in accordance with the preferred embodiments to improve performance of a query to a partitioned database.

### BEST MODE FOR CARRYING OUT THE INVENTION

The preferred embodiments evaluate performance of a query to a partitioned database, determine what resources are available for potential reallocation, evaluate performance of the query based on a proposed reallocation, and iterate in an attempt to find the allocation of resources that provides the best performance for the query. Once found, the reallocation of resources is initiated, thereby causing an autonomic reallocation of resources among logical partitions to optimize the performance of a query to a partitioned database.

Two different types of partitions are discussed herein, and some explanation is required to clarify what the two terms mean. The first is a logical partition. Logical partitions are logical divisions on a computer system that allow each logical partition to appear and operate as a separate and distinct computer system. Thus, a single computer system could be partitioned into three logical partitions, making the single computer system logically appear to be three separate computer systems. Logical partitioning is a very cost-effective way to provide computer services to many customers, because each customer's applications and data may be in a logical partition corresponding to the customer. In this manner, many different customers may be serviced by a single computer system that includes multiple logical partitions.

The second type of partition discussed herein is a database partition. Database partitions are fundamentally different than logical partitions. It may be desirable to partition a database among multiple systems. A partitioned database may have a first table on a first system, and a second table on a second system. A partitioned database may have also or alternatively have a first portion of a table on a first system, and a second portion of the same table on a second system. A database partition manager manages the various database partitions, and hides the partitioning of the database from applications and users that access the database. Note that the term “system” used above regarding database partitions could be a physical computer system, or could be a logical partition in a computer system. Thus, a database table with four partitions could reside on four physical computer systems, could reside on a single computer system that includes four logical partitions, or could reside on any combination of physical computer systems and logical partitions that contain the four separate database partitions. Care is taken to distinguish between logical partitions and database partitions in the usage of these terms in this specification.

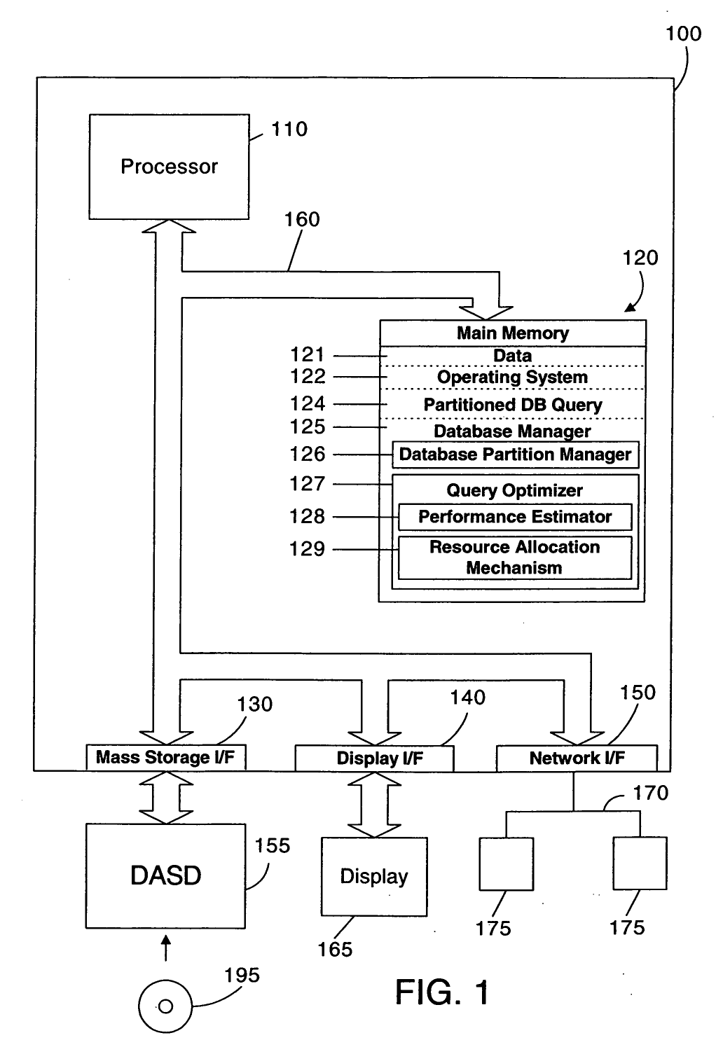

Referring to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD RW drive, which may store data to and read data from a CD RW 195.

Main memory 120 in accordance with the preferred embodiments contains data 121, an operating system 122, a partitioned database query 124, and a database manager 125. Data 121 represents any data that serves as input to or output from any program in computer system 100. Operating system 122 is a multitasking operating system known in the industry as i5/OS; however, those skilled in the art will appreciate that the spirit and scope of the present invention is not limited to any one operating system. The partitioned database query 124 is a query, such as a query written in Structured Query Language (SQL), to a partitioned database. Note that the query itself does not know that the database is partitioned, but is a partitioned query by virtue of referencing data that reside in different portions of a partitioned database. The database manager 125 includes a database partition manager 126, which effectively hides the fact that the database is partitioned from users or applications that access the database. Thus, a query 124 may access a table that is partitioned across three different systems, and database partition manager 126 then interacts with the database partitions to retrieve the requested data. Database manager 125 also includes a query optimizer 127 that is used to optimize the performance (i.e., execution time) for query 124. The query optimizer 127 preferably includes a performance estimator 128 and a resource allocation mechanism 129. The performance estimator 128 is used to estimate the performance of a query. The performance estimator 128 preferably divides the query into sub-parts, and estimates the performance for each sub-part. The slowest sub-part governs the performance of the entire query. For this reason, if resources can be reallocated to achieve a net increase in performance for the slowest sub-part of the query, the overall performance of the query will improve.

The resource allocation mechanism 129 is used to determine what resources are available to the logical partitions that include database partitions referenced in the query, and to propose reallocation of resources in an effort to improve performance of the query. The resource allocation mechanism 129 and performance estimator 128 preferably operate in an iterative manner so a best allocation of resources may be determined. Once a best allocation of resources is found for executing the query 124, and if this best allocation requires reallocation of resources, the resource allocation mechanism 129 initiates reallocation of the resources among logical partitions. In this manner, the database manager autonomically reallocates resources among logical partitions to enhance the performance of the query 124.

The resources that may be allocated in a logical partition include processors, memory, disk drives, I/O slots, I/O adapters, etc. The preferred embodiments expressly extend to dynamically reallocating any suitable resource that may be allocated to a logical partition, including processors and memory that will have a measurable impact on query performance.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, partitioned database query 124, and database manager 125 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiments each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD RW (e.g., 195 of FIG. 1), and transmission type media such as digital and analog communications links. Note that the preferred signal bearing media is tangible.

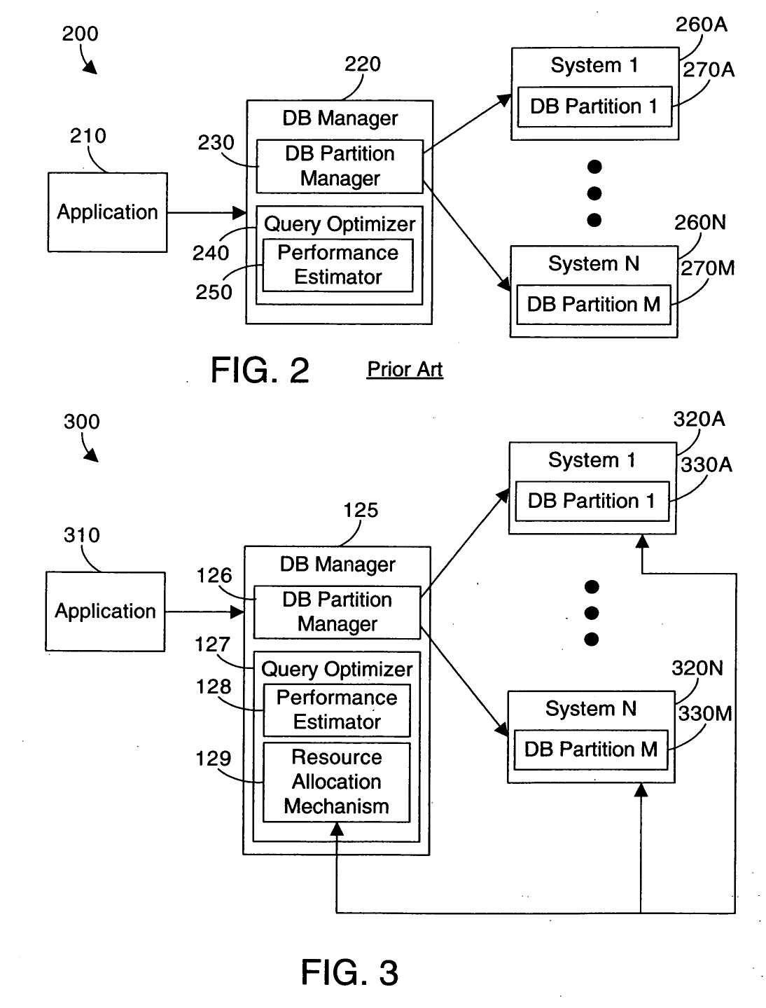

Referring to FIG. 3, a computer system 300 in accordance with the preferred embodiments includes an application 310 that accesses a partitioned database via a database manager 125. As in the prior art system 200 in FIG. 2, the fact that the database is partitioned is hidden from the application 310 by the database manager 125. Multiple database partitions are preferably dispersed among a plurality of systems. Thus, FIG. 3 shows a first database partition 330A residing in a first system 320A, and an Mth database partition 330M residing in an Nth system 320N. Note that multiple partitions may be in a single system, creating a potential mismatch between the number of partitions and the number of systems. The systems 320A, . . . , 320N in FIG. 3 may be physical computer systems, may be logical partitions, or may be any suitable combination of the two.

The database manager 125 includes a database partition manager 126 that manages the different partitions in the partitioned database. Thus, in FIG. 3 database partition manager 126 is shown managing the database partitions 330A, . . . , 330M in the different systems 320A, . . . , 320N. The database manager 125 includes a query optimizer 127, which includes a performance estimator 128 and a resource allocation mechanism 129. The performance estimator 128 is used to estimate performance of a query to the partitioned database. The resource allocation mechanism 129 is used to determine what resources are available on the systems 320A, . . . , 320N, and to formulate a proposed reallocation of resources. The performance estimator 128 may then estimate performance of the query based on the proposed resource allocation to see if the proposed resource allocation improves performance of the query. The performance estimator 128 and resource allocation mechanism 129 preferably operate in an iterative manner in an attempt to formulate multiple proposed resource allocations and to see which of the proposed resource allocations, if any, provide enhanced performance for executing the query compared to the existing (or initial) resource allocation.

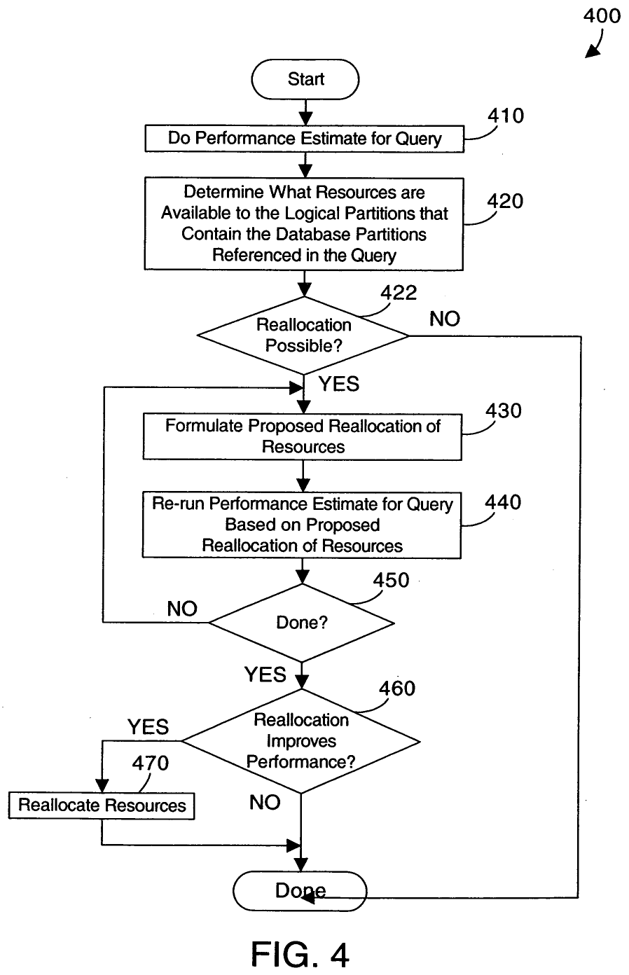

Referring to FIG. 4, a method 400 in accordance with the preferred embodiments autonomically adjusts resource allocation in one or more logical partitions to improve the performance of a query that accesses a partitioned database. Method 400 could be performed, for example, by query optimizer 127 in FIG. 3. First, a performance estimate for the query is performed (step 410). The resources available to the logical partitions that contain the database partitions referenced in the query are then determined (step 420). If reallocation of the resources is not possible (step 422=NO), method 400 is done. If reallocation of resources is possible (step 422=YES), a proposed reallocation of resources is then formulated (step 430). The performance estimate for the query is then re-run based on the proposed reallocation of resources (step 440). If more proposed reallocations need to be formulated (step 450=NO), method 400 returns to step 430, and steps 430 and 440 are then repeated for each proposed reallocation until all desired proposed reallocations have been processed (step 450=YES). If no proposed reallocation of resources improves performance of the query (step 460=NO), method 400 is done. If one or more of the reallocation of resources improves performance of the query (step 460=YES), the resources are reallocated (step 470), preferably according to the proposed reallocation of resources that provided the desired performance for the query. Method 400 thus provides a way to autonomically adjust the allocation of resources between logical partitions that contain database partitions of a partitioned database.

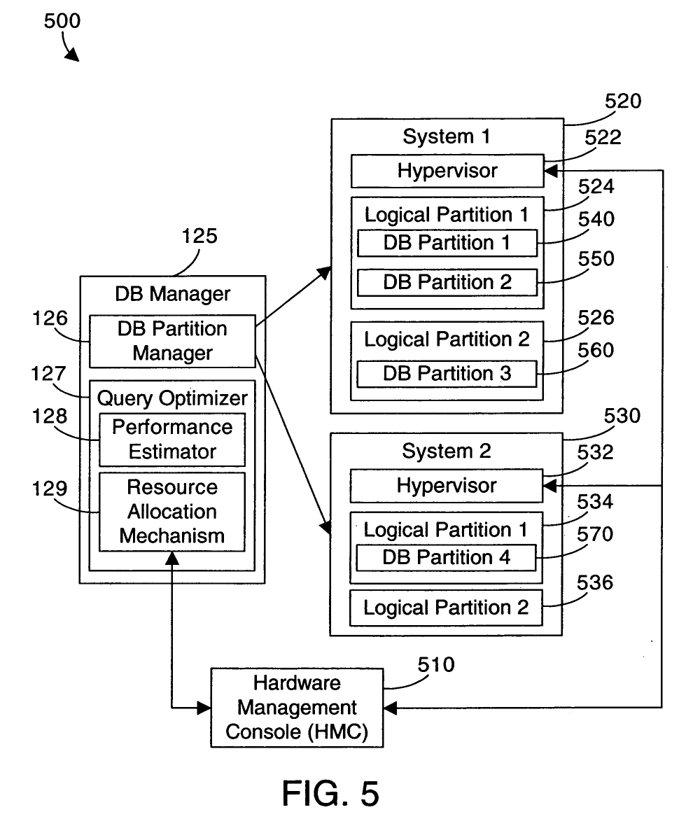

Referring to FIG. 5, a computer system 500 in accordance with the preferred embodiments shows one specific implementation for system 300 in FIG. 3. The database manager 125 is the same as in computer system 300 shown in FIG. 3, which is described in detail above. For this specific example, we assume there are two physical boxes (or computer systems) 520 and 530. System 520 includes a hypervisor 522, which is an IBM term for a supervisory program that creates and manages logical partitions. In this specific example, system 520 includes two logical partitions 524 and 526 that are initially created, then later managed by hypervisor 522. We assume that the first logical partition 524 includes first and second database partitions 540 and 550, respectively, and the second logical partition 526 includes a third database partition 560. System 530 includes a hypervisor 532 that creates and manages two logical partitions 534 and 536. Logical partition 534 includes a fourth database partition 570, while logical partition 536 does not include any database partition.

Logical partitions in IBM computer systems may be externally controlled using a hardware management console (HMC) 510. The HMC 510 has a communication link with the hypervisors 522 and 532. The HMC 510 may determine from the hypervisors 522 and 532 the resources in each system 520 and 530, respectively, and how these resources are allocated among the logical partitions. The HMC 510 includes a command-line interface that allows the resource allocation mechanism 129 to initiate the reallocation of resources in one or more logical partitions. The HMC provides the tool that allows the resource allocation mechanism 129 to determine initial (or current) allocation of resources, to formulate a proposed reallocation of resources, and to initiate a reallocation of resources. Once the resource allocation mechanism 129 initiates reallocation of resources by one or more appropriate commands to the HMC 510, the HMC 510 then commands the hypervisors 522 and/or 532 to perform the requested reallocation of resources.

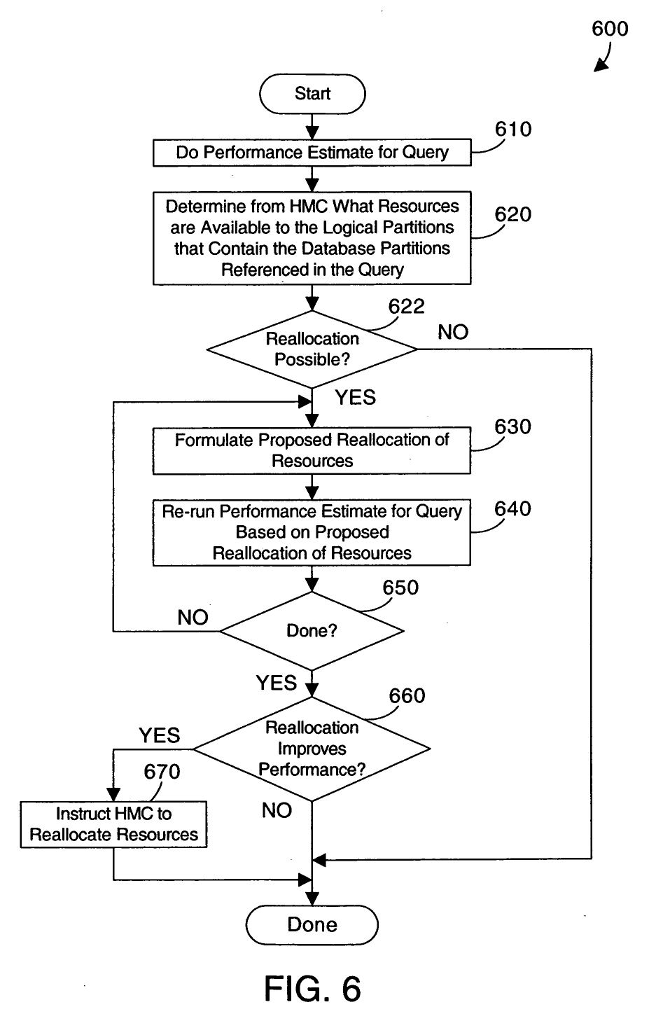

Referring to FIG. 6, a method 600 in accordance with the preferred embodiments does a performance estimate for a query (step 610) based on a current allocation of resources. The resource allocation mechanism 129 then determines from the HMC 510 what resources are available to the logical partitions that contain the database partitions referenced in the query (step 620). If reallocation is not possible (step 622=NO), method 600 is done. If reallocation is possible (step 622=YES), a proposed reallocation of resources is then formulated (step 630). The performance estimate for the query is then re-run based on the proposed reallocation of resources (step 640). Steps 630 and 640 are repeated (step 650=NO) for any suitable number of proposed reallocations of resources, until all desired reallocation of resources have been considered (step 650=YES). If one or more of the proposed reallocations improves performance of the query (step 660=YES), the resource allocation mechanism 129 instructs the HMC 510 to reallocate resources (step 670) according to a selected proposed reallocation. In response, the HMC 510 directs the hypervisors 522 and/or 532 to perform the desired reallocation of resources.

A simple example is now presented to illustrate how reallocation of resources might be performed. Let's assume query 124 includes four separate and distinct parts that may be processed independently of each other, with subpart A referencing database partition 540, subpart B referencing database partition 550, subpart C referencing database partition 560, and subpart D referencing database partition 570 in FIG. 5. Now let's assume that system 520 includes six processors and 384 MB of memory, with four processors and 128 MB of memory allocated by the hypervisor 522 to the first logical partition 524, and two processors and 256 MB of memory allocated by the hypervisor 522 to the second logical partition 526. Let's also assume that system 530 includes four processors and 512 MB of memory, with three processors and 384 MB of memory allocated by the hypervisor 532 to the first logical partition 534, and the remaining one processor and 128 MB of memory allocated by the hypervisor 532 to the second logical partition 536.

We now assume the performance estimator estimates performance of the query, and determines that subpart A takes 12 ms to process, subpart B takes 5 ms to process, subpart C takes 2.35 seconds to process, and subpart D takes 264 ms to process. With this estimated performance, we see that subpart C is the slowest portion of the query. We also see that subpart C is executed by the logical partition 526 that has two processors and 256 MB of memory, while subparts A and B, which are orders of magnitude faster in execution time than subpart C, is executed by the logical partition 524 that has four processors and 256 MB of memory. As a result, a proposed reallocation of resources for logical partitions 524 and 526 might be three processors in each logical partition, with memory unchanged. The performance estimator can now estimate the performance of the query based on this proposed reallocation, and determine how the estimate is affected by the reallocation. Let's assume for this example that the proposed reallocation of three processors for logical partition 524 and three processors for logical partition 526 results in the following estimate: subpart A takes 38 ms to process, subpart B takes 5 ms to process, subpart C takes 1.15 seconds to process, and subpart D takes 264 ms to process. We see from this example that reallocating one processor from logical partition 524 to logical partition 526 results in executing the query in less than half the time. As a result, this proposed reallocation could be used to initiate an actual reallocation. Note also that the process could continue to iterate, with various combinations of processor and memory reallocation, to determine an optimum reallocation of resources based on the desired query performance.

The examples discussed above are simplistic in their assumption that the performance of a single query may be optimized by reallocating resources in one or more logical partitions. However, one skilled in the art will recognize that many queries may be executed by a database manager, and dynamically reallocating resources among logical partitions each time a different query is run may result in dynamic reallocation for each query, which would greatly slow down system performance. To address this issue, there are many different ways to determine when the resource allocation mechanism kicks in to find a proposed reallocation of resources, and when the resource allocation mechanism initiates a reallocation of resources. For example, it is possible that two different queries may have different, competing resource allocations that optimize their respective performance. In this situation, the query that “wins” may be determined by any suitable method, including having a user or system administrator select which of the queries to process for possible reallocation of resources, weighting the two queries based on the number of times they are executed or the total execution times of the queries in a given time period, etc. Any suitable heuristic could be used to govern when reallocation of resources is performed, and when a change to the reallocation of resources is allowed. For example, time could be used as the determining factor by reallocating resources only when a query is estimated to take longer than the query that resource was moved for in the first place. Other factors such as priorities and time slices may be used in determining whether resource reallocation is needed. Weighting of concurrent queries could also be done to decide proper resource shifting that produces the highest overall benefit, or benefits the most critical queries the most. Reallocation could also be done based on user-specified queries, jobs, etc. In addition, the reallocation might be restricted to only certain time periods. Historical data could also be used to determine when to perform a reallocation of resources. Historical data can help to understand which queries might need dynamic resource reallocation, and can be used to trigger the resource allocation through predetermined thresholds. In other words, a threshold of 1,000 could be defined that would prevent any query from triggering a resource reallocation until it has been executed 1,000 times. A time threshold could also be established that would initiate the methods of the preferred embodiments for any query that takes longer than a specified time to execute, such as five seconds. A filter could also be established that initiates the methods of the preferred embodiments only for a specified user or users. These and other variations are within the scope of the preferred embodiments, which expressly extend to any dynamic reallocation of resources in one or more logical partitions to improve performance of a query to a database with partitions that reside in the logical partitions.

The preferred embodiments provide a way to autonomically adjust the allocation of resources in logical partitions according to the performance of a query that references multiple database partitions in the logical partitions. By dynamically reallocating resources in logical partitions according to query performance, the preferred embodiments provide a computer system that autonomically adjusts to improve performance over time.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. A computer system comprising:
a plurality of logical partitions;
a plurality of database partitions residing in the plurality of logical partitions;
a resource allocation mechanism that determines an initial allocation of resources in the plurality of logical partitions and determines a proposed reallocation of resources in the plurality of logical partitions; and
a performance estimator that estimates performance of a query with the initial allocation of resources and estimates performance of the query with the proposed reallocation of resources.

2. The computer system of claim 1 wherein, if the estimated performance of the query with the proposed reallocation of resources is better than the estimated performance of the query with the initial allocation of resources, the resource allocation mechanism initiates the proposed reallocation of resources in the plurality of logical partitions.

3. The computer system of claim 1 wherein the resource allocation mechanism and performance estimator iterate to find an allocation of resources that provides desired performance for the query.

4. The computer system of claim 3 wherein the resource allocation mechanism initiates reallocation of resources in the plurality of logical partitions to provide the allocation of resources that provides the desired performance for the query.

5. The computer system of claim 1 wherein the resources are selected from the group consisting of:
processors;
memory; and
disk drives.

6. The computer system of claim 1 further comprising a hardware management console coupled to the plurality of logical partitions that controls allocation of resources in the plurality of logical partitions.

7. A computer-implemented method for autonomically reallocating resources in a plurality of logical partitions, the method comprising the steps of:
(A) estimating performance of a query to a partitioned database;
(B) determining resources available in the plurality of logical partitions;
(C) determining a proposed reallocation of the resources in the plurality of logical partitions; and
(D) estimating performance of the query with the proposed reallocation of resources in the plurality of logical partitions.

8. The method of claim 7 wherein, if the estimated performance of the query in step (D) is better than the estimated performance of the query in step (A), initiating the proposed reallocation of resources in the plurality of logical partitions.

9. The method of claim 7 wherein steps (C) and (D) are performed iteratively to find an allocation of resources that provides desired performance for the query.

10. The method of claim 9 further comprising the step of initiating reallocation of resources in the plurality of logical partitions to provide the allocation of resources that provides the desired performance for the query.

11. The method of claim 7 wherein the resources are selected from the group consisting of:
processors;
memory; and
disk drives.

12. The method of claim 7 wherein a hardware management console coupled to the plurality of logical partitions controls allocation of resources in the plurality of logical partitions.

13. A computer-readable program product comprising:
(A) a resource allocation mechanism that determines an initial allocation of resources in a plurality of logical partitions and determines a proposed reallocation of resources in the plurality of logical partitions;
(B) a performance estimator that estimates performance of a query with the initial allocation of resources and estimates performance of the query with the proposed reallocation of resources; and
(C) computer-readable signal bearing media bearing the resource allocation mechanism and the performance estimator.

14. The program product of claim 13 wherein the computer-readable signal bearing media comprises recordable media.

15. The program product of claim 13 wherein the computer-readable signal bearing media comprises transmission media.

16. The program product of claim 13 wherein, if the estimated performance of the query with the proposed reallocation of resources is better than the estimated performance of the query with the initial allocation of resources, the resource allocation mechanism initiating the proposed reallocation of resources in the plurality of logical partitions.

17. The program product of claim 13 wherein the resource allocation mechanism and performance estimator iterate to find an allocation of resources that provides desired performance for the query.

18. The program product of claim 17 wherein the resource allocation mechanism initiates reallocation of resources in the plurality of logical partitions to provide the allocation of resources that provides the desired performance for the query.

19. The program product of claim 13 wherein the resources are selected from the group consisting of:
processors;
memory; and
disk drives.
